(19) United States
(12) Patent Application Publication
(10) Pub. No.: US 2005/0103064 A1
(43) Pub. Date: May 19, 2005

(54) Washing machine

(75) Inventors: Kyu Chai Lee, Suwon-si (KR); Koan Seog Namkung, Hwasung-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/901,218

(22) Filed: Jul. 29, 2004

(30) Foreign Application Priority Data
Nov. 18, 2003 (KR) 2003-81562

(51) Int. Cl. B03C 7/00

(52) U.S. Cl. 68/232

(57) ABSTRACT

A washing machine which includes the outer casing having a box-shaped body to define a frame thereof and upper and lower plates. The upper plate is mounted to an upper portion of the body, and the lower plate is mounted to a lower portion of the body. The lower plate is integrated with a lower reinforcing plate to reinforce the strength of a lower portion of a rear surface of the body. The washing machine of the present invention reduces a number of parts, thus allowing the outer casing to be easily manufactured and enhancing productivity. Further, the washing machine allows the lower plate and the lower reinforcing plate to be made of a thin steel plate when the outer casing is manufactured, thus reducing manufacturing costs of the outer casing.

### CROSS-REFERENCE TO RELATED APPLICATIONS

This application claims the benefit of Korean Patent Application No. 2003-81562, filed on Nov. 18, 2003 in the Korean Intellectual Property Office, the disclosure of which is incorporated herein by reference.

### BACKGROUND OF THE INVENTION

1. Field of the Invention

The present invention relates, in general, to washing machines, and more particularly, to a washing machine which is constructed to enhance manufacturability and productivity of an outer casing of the washing machine.

2. Description of the Related Art

Generally, a washing machine includes an outer casing to define a frame of the washing machine, a water tub which is set in the outer casing to contain wash water therein, a rotary tub and a pulsator which execute a washing operation, and a drive unit to drive the above-mentioned elements.

The outer casing of the washing machine includes a body, an upper plate, and a lower plate. The body is box shaped, and is opened at upper and lower portions thereof. The upper plate covers the upper portion of the body. The lower plate is mounted to the lower portion of the body. Further, a plurality of support legs are provided on the lower plate to support the washing machine.

In the body of the outer casing, a front wall and opposite sidewalls of the body are integrally formed by bending a steel plate. A rear wall of the body includes an upper reinforcing plate, a lower reinforcing plate, and a rear panel. The upper reinforcing plate is mounted, at opposite ends thereof, to upper portions of rear ends of the opposite sidewalls. The lower reinforcing plate is mounted, at opposite ends thereof, lower portions of the rear ends of the opposite sidewalls. The rear panel is detachably mounted, at opposite ends thereof, to the rear ends of the opposite sidewalls, and covers a space between the upper and lower reinforcing plates. The rear panel is detached from the body of the outer casing when repair is required.

When the outer casing of the washing machine is manufactured, the body, the upper plate, and the lower plate are separately manufactured, and then assembled with each other using various securing methods, for example, a welding process, a riveting process, or a bolting process. The front wall and the opposite sidewalls of the body are integrally formed by bending the steel plate. Further, the upper and lower reinforcing plates and the rear panel are separately manufactured, and then are mounted to a rear portion of the washing machine.

The conventional washing machine has a problem in that a manufacturing process is complicated and productivity is low, because various parts are separately manufactured, and then assembled with each other to provide the outer casing of the washing machine.

### SUMMARY OF THE INVENTION

Accordingly, it is an aspect of the present invention to provide a washing machine, which is constructed so that parts of an outer casing are integrated with each other into a single structure, thus making it easy to manufacture the outer casing, and enhancing productivity.

Additional aspects and/or advantages of the invention will be set forth in part in the description which follows and, in part, will be obvious from the description, or may be learned by practice of the invention.

The foregoing and/or other aspects are achieved by providing a washing machine comprising an outer casing comprising a body to define a frame of the outer casing, and upper and lower plates. The upper plate is mounted to an upper portion of the body, and the lower plate is mounted to a lower portion of the body. The lower plate is integrated with a lower reinforcing plate to reinforce a strength of a lower portion of a rear surface of the body.

According to another aspect of the invention, the body comprises a front wall and opposite sidewalls which are integrally formed by bending a steel plate, and a rear wall. The rear wall comprises the lower reinforcing plate, an upper reinforcing plate, and a rear panel. The upper reinforcing plate is mounted to upper portions of rear ends of the opposite sidewalls. The rear panel is detachably mounted to the rear ends of the opposite sidewalls to cover a space between the upper and lower reinforcing plates.

In another aspect of this embodiment, the lower plate and the lower reinforcing plate may be fabricated into a single structure by bending a steel plate.

### BRIEF DESCRIPTION OF THE DRAWINGS

These and/or other aspects and advantages of the invention will become apparent and more readily appreciated from the following description of the embodiments, taken in conjunction with the accompanying drawings of which:
FIG. 1 is a sectional view of a washing machine, according to an embodiment of the present invention; and
FIG. 2 is an exploded perspective view of an outer casing of the washing machine of FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout. The embodiment is described below in order to explain the present invention by referring to the figures.

The present invention is applied to a drum-type washing machine, as shown in FIG. 1. The drum-type washing machine comprises an outer casing 10, a cylindrical water tub 20, and a cylindrical rotary tub 21. The outer casing 10 defines an external appearance of the washing machine. The cylindrical water tub 20 is located in the outer casing 10 to contain wash water therein. The cylindrical rotary tub 21 is rotatably set in the water tub 20, and includes perforations on a sidewall of the rotary tub 21. Further, each of the water tub 20, the rotary tub 21, and the outer casing 10 comprises an opening at a front thereof, thus providing a front opening 22. The front opening 22 communicates with the rotary tub 21, wherein a user puts and takes laundry into and from the rotary tub 21 through the front opening 22. A door 23 is mounted to the front of the outer casing 10 to open or close the front opening 22.

The drum-type washing machine further comprises a water supply control unit 24 and a detergent supply unit 25. The water supply control unit 24 is provided at a predetermined position above the water tub 20 to supply wash water to the water tub 20. The detergent supply unit 25 is provided at a predetermined position above the water tub 20 to supply a detergent to the water tub 20. A drive motor 26 is installed at a position between a bottom portion of the water tub 20 and a bottom portion of the outer casing 10 to rotate the rotary tub 21. A drain unit comprising a drain pump 27 and a drain pipe 28, is installed under the water tub 20 to discharge the wash water to an outside of the washing machine. Further, a plurality of lifters 21a horizontally extend along an inner surface of the rotary tub 21. The lifters 21a are projected from the inner surface of the rotary tub 21 to move the laundry and the wash water upward when the rotary tub 21 rotates. The laundry and the wash water drop down in the rotary tub due to gravity.

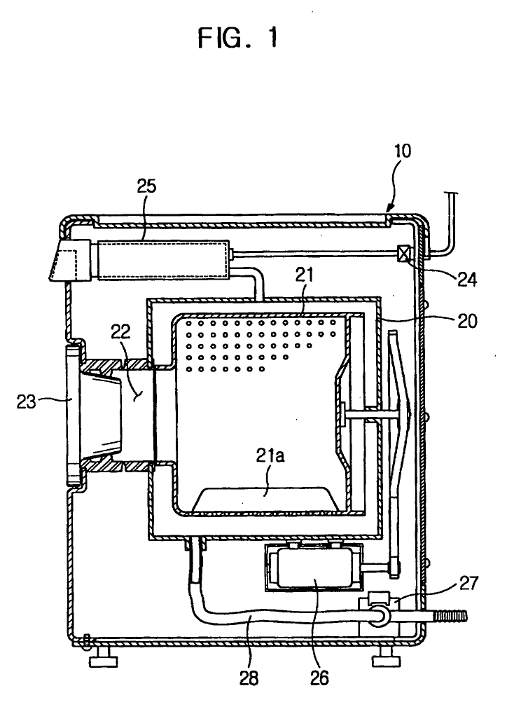

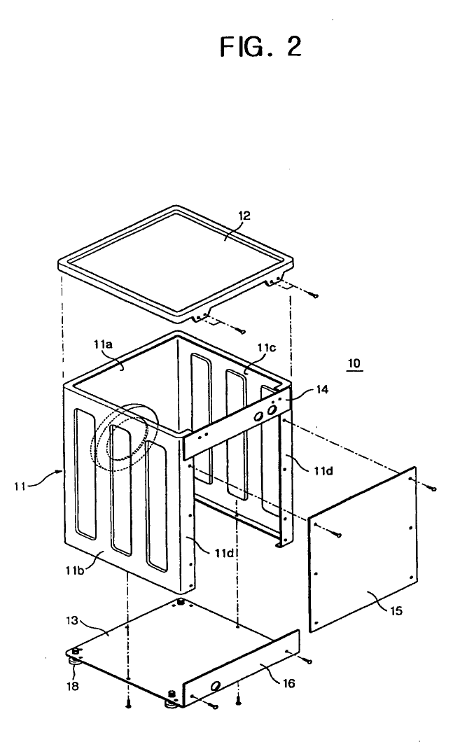

In FIG. 2, the outer casing 10 comprises a body 11, an upper plate 12, and a lower plate 13. The body 11 is box shaped, and is opened at upper and lower portions thereof. The upper plate 12 covers the upper portion of the body 11. The lower plate 13 is mounted to the lower portion of the body 11. Further, a plurality of support legs 18 are provided on the lower plate 13 to support the washing machine.

In the body 11 of the outer casing 10, a front wall 11a and opposite sidewalls 11b and 11c are integrally formed by bending a steel plate. A rear wall of the body 11 comprises an upper reinforcing plate 14, a lower reinforcing plate 16, and a rear panel 15. The upper reinforcing plate 14 is mounted, at opposite ends thereof, to upper portions of rear ends of the opposite sidewalls 11b and 11c. The lower reinforcing plate 16 is mounted, at opposite ends thereof, to lower portions of the rear ends of the opposite sidewalls 11b and 11c. The rear panel 15 is detachably mounted, at opposite ends thereof, to the rear ends of the opposite sidewalls 11b and 11c, and covers an opening between the upper and lower reinforcing plates 14 and 16. In this case, a mounting part 11d is provided at each of the rear ends of the opposite sidewalls 11b and 11c so that the upper reinforcing plate 14, the rear panel 15, and the lower reinforcing plate 16 are mounted to the rear ends of the opposite sidewalls 11b and 11c.

According to the present invention, the outer casing 10 is constructed so that the lower reinforcing plate 16 provided on a rear portion of the body 11 is integrated with the lower plate 13 mounted to the lower portion of the body 10 by bending the steel plate. Such a construction allows the outer casing 10 to be easily manufactured, in addition to reducing the number of parts constituting the outer casing 10. In a detailed description, when the lower plate 13 is manufactured, the lower plate 13 is bent at a rear end thereof and upwardly extends to a predetermined position, thus forming the lower reinforcing plate 16.

Since the outer casing 10 is constructed so that the lower plate 13 and the lower reinforcing plate 16 are integrated with each other, the number of the parts of the outer casing 10 is reduced. Further, such a construction allows the outer casing 10 to be more easily manufactured, and reduces the amount of labor required to manufacture the outer casing 10, thus enhancing productivity of the washing machine.

In the drum-type washing machine of the present invention, the lower plate 13 is integrated with the lower reinforcing plate 16 into a single structure. Thus, the lower portion of the outer casing 10 is stronger, in comparison to a conventional washing machine which is constructed so that a lower plate and a lower reinforcing plate of an outer casing are separately manufactured. Such a construction allows a thickness of the steel plate to be reduced to 80% of a thickness of a steel plate of the outer casing of the conventional washing machine while maintaining the strength of the outer casing of the conventional washing machine, thus reducing the manufacturing costs of the lower plate 13 and the lower reinforcing plate 16 of the outer casing 10.

As is apparent from the above description, the present invention provides a washing machine, which is constructed so that a lower plate of an outer casing is integrated with a lower reinforcing plate of a rear portion of a body, thus reducing the number of parts of the outer casing, therefore allowing the outer casing to be easily manufactured, and enhancing productivity of the washing machine.

Further, according to the present invention, the lower plate is integrated with the lower reinforcing plate into a single structure, thus having strength stronger than a lower portion of an outer casing of a conventional washing machine, and thereby allowing the lower plate and the lower reinforcing plate to be made of a thin steel plate when the outer casing is manufactured. Therefore, the manufacturing costs of the outer casing are reduced.

Although an embodiment of the present invention has been shown and described, it would be appreciated by those skilled in the art that changes may be made in these embodiments without departing from the principles and spirit of the invention, the scope of which is defined in the claims and their equivalents.

1. A washing machine, comprising:
an outer casing comprising:
a body to define a frame of the outer casing;
an upper plate mounted to an upper portion of the body; and
a lower plate mounted to a lower portion of the body, the lower plate being integrated with a lower reinforcing plate to reinforce a strength of a lower portion of a rear surface of the body.

2. The washing machine of claim 1, wherein the body comprises:
a front wall and opposite sidewalls integrally formed by bending a steel plate; and
a rear wall, comprising:
the lower reinforcing plate;
an upper reinforcing plate mounted to upper portions of rear ends of the opposite sidewalls; and
a rear panel detachably mounted to the rear ends of the opposite sidewalls to cover an opening between the upper and lower reinforcing plates.

3. The washing machine of claim 1, wherein the lower plate and the lower reinforcing plate are fabricated into a single structure by bending a steel plate.

4. A washing machine, comprising:
an outer casing to define an external appearance of the washing machine and comprising:
a body to define a frame of the outer casing;
an upper plate mounted to an upper portion of the body; and
a lower plate mounted to a lower portion of the body, wherein the lower plate is bent at a rear end thereof and extends upwardly to a predetermined position, to reinforce a strength of a lower portion of a rear surface of the body.

5. The washing machine of claim 4, wherein the body comprises:
a front wall and opposite sidewalls integrally formed by bending a steel plate; and
a rear wall comprising:
lower and upper reinforcing plates mounted to upper and lower portions of rear ends of the opposite side walls, respectively, and
a rear panel detachably mounted to the rear ends of the opposite side walls to cover an opening between the upper and lower reinforcing plates.

6. A drum-type washing machine, comprising:
an outer casing comprising:
a body to define a frame of the outer casing;
an upper plate mounted to an upper portion of the body; and
a lower plate mounted to a lower portion of the body, the lower plate being integrated with a lower reinforcing plate to reinforce a strength of a lower portion of a rear surface of the body.
